(19) United States
(12) Patent Application Publication
(10) Pub. No.: US 2007/0208650 A1
(43) Pub. Date: Sep. 6, 2007

(54) System and method for creating, listing, and clearing flexible short term interest rate derivative instruments

(76) Inventors: Bradley J. McGill, Birmingham, AL (US); C. Todd McCormick, New York, NY (US); Daniel A. Sanabria, Birmingham, AL (US)

Correspondence Address: Daniel H. Golub, 1701 Market Street, Philadelphia, PA, 19103-2921, US

(21) Appl. No.: 11/637,956

(22) Filed: Dec. 12, 2006

Related U.S. Application Data
(60) Provisional application No. 60/749,402, filed on Dec. 12, 2005.

(51) Int. Cl. G06Q 40/00

(52) U.S. Cl. 705/37

(57) ABSTRACT

The present invention relates to a process for designing, creating and distributing financial instruments which allow investors to trade flex short term interest derivative contracts that can be customized to meet its investor's needs by choosing the actual terms of the contract from a list of flexible features that include but are not limited to strike prices, start and expiration dates or option pay-out styles. The designed investment vehicle would provide a relatively inexpensive choice to investors looking to hedge specific exposures to the movement of short term interest rate indicators in an exchange-listed environment. The result of this functionality benefits the customers and brokerage firms in the sense that the contracts proposed in the present invention are an attractive hybrid of listed and OTC markets, offering the best of each.

### CROSS REFERENCE TO RELATED APPLICATIONS

This application claims priority to U.S. provisional application Ser. No. 60/749,402 filed on Dec. 12, 2005 entitled “System and Method for Creating, Listing, and Clearing Flexible Short Term Interest Rate Derivative Instruments.”

### FIELD OF THE INVENTION

The present invention relates to a method for implementing features of flex derivative contracts to the trading of short term interest rate derivative securities.

### BACKGROUND OF THE INVENTION

A derivative instrument or product (derivative) is a tradable instrument whose value is derived from the price of some underlying asset. Derivatives include futures contracts, futures on stock market indices, options and swaps, and can be used as a hedge to reduce risk, or for speculation. A derivative in the instruments, trading, insurance, and economics communities includes an instrument or contract whose value depends on such factors as the value of an underlying instrument, index, asset or liability, or on a feature of such an underlying instrument such as interest rates or convertibility into some other instrument. Financial futures on stock indices or options to buy and sell such futures contracts are highly popular exchange-traded financial derivatives. Derivatives may also be traded on commodities, insurance events, and other events, such as the weather.

In the past 15 years the growth in derivatives trading has been enormous. Corporations, financial institutions, and national governments and agencies are all active in the derivatives markets to better manage asset and liability portfolios, hedge financial market risk, and minimize costs of capital funding. Money managers also use derivatives to hedge and undertake economic exposure where there are inherent risks, such as risks of fluctuation in interest rates, foreign exchange rates, convertibility into other instruments or outstanding purchase offers for cash or exchange offers for cash or instruments.

A “listed” derivative is traded on exchanges, such as the option and futures contracts traded on the Chicago Board of Trade, while an off-exchange or over-the-counter derivative is traded between two or more derivative counterparties. On the major exchanges, orders are transmitted to member brokers who execute the orders and usually balance or hedge their own portfolio of derivatives to suit their own risk and return criteria. Hedging is usually accomplished by trading in the derivatives' underlying instruments or contracts or in similar derivatives. By far, the largest types of listed derivatives are the interest rate contracts traded on leading futures exchanges, such as the Eurodollar futures and options contracts on the Chicago Mercantile Exchange and the Treasury and Fed Funds futures and options on the Chicago Board of Trade. As an example, the CME trades on average 2.5 million Eurodollar futures and options per day, with a total notional value of $2.5 trillion.

Listed derivatives, and particularly futures and options on futures, share many common characteristics. The contract specifications for a given contract are fixed, with standardized notional values, trading hours, expirations and tick sizes. The trading and clearing processes are also universal. In virtually all implementations, a broker, often called a Futures Commission Merchant (FCM), will submit order to an exchange. The exchange will expose this order to the broader market, either on the floor of the exchange or electronically on a trading platform. Once a match is made between buyer and seller, the trade is submitted to a clearing facility for processing.

Historically, an exchange will develop many new contracts, and some percentage of those will prove to be successful. A notable contract implementation that has proven to be successful representing tremendous volume and rapid growth in the listed derivatives business was the introduction in 1993 of FLEX options contracts by the Chicago Board of Options Exchange (CBOE).

A Flex option is a derivative instrument that can be customized to meet its investor's needs as it allows the investor to choose the actual terms of the contract from a list of flexible features that include strike prices, expiration date or option pay-out style among others. Since the introduction of such instruments, a number of exchanges have applied the flexibility of these options to offer an ample array of index investing opportunities. For example, the CBOE has Flex options listed on equity indices including the S&P100, S&P500, Nasdaq 100, Dow Jones Industrial Average, and the Russell Index (a basket of 2000 of the derivative small-capitalization stocks).

Also in 1993, the Swedish's exchange Options Market (OM) began offering a “TailorMadeClearing” option. The particular option permitted an investing member to decide many of the characteristics of their investment vehicle in terms of type of option, underlying assets, exercise period or exercise price.

In addition to being implemented as indexed contracts. The FLEX option model has also been applied to individual equities as well as currency option contracts and several domestic as well as foreign exchanges such as the Chicago Board of Trade, the American Stock Exchange, the Philadelphia Stock Exchange, the London International Financial Futures Exchange and the MATIF (Marché à Terme International de France) are currently listing similar products.

The FLEX options have also been introduced in the long term interest rates and treasury business. For purposes of this application, the term “long term” means interest rates on instruments have a maturity greater than 1 year. The Chicago Board of Trade (CBOT) offers flexible treasury options written on U.S. Treasury bonds and bills which allow for investors' choice of exercise price, expiration date and style.

As the examples presented reveal, a number of applications have been attempted to increase the use of FLEX options. However, with the tremendous volume and rapid growth of the listed flexible derivatives business and the prevalence of broadly dispersed Flexible Facilities in licensed, regulated futures exchanges, it is surprising that the market has not seen the introduction of flexible and customizable derivative instruments which are underlined to the value of a short-term interest rate indicator. This result may be due to the absence of an effective method to facilitate the establishment of a listed Short Term Interest Rate (STIR) derivative product that includes the flexible features of a FLEX option.

### SUMMARY OF THE INVENTION

If an effective method to facilitate the establishment of a listed Short Term Interest Rate (STIR) derivative product that includes the flexible features of a FLEX option were available, the rate of success in creating competitive trading venues for such a product would be substantially higher, benefiting different market participants and offering new investment option opportunities to STIR investors. Offering flexible characteristics to existing STIR listed would allow new expiries, payouts, rates and other innovative features that are only currently offered in the OTC markets. A listed flexible environment in the trading of STIR would enable brokers to structure a wide range of transactions in the listed market. For example, a LIBOR/Fed Funds relative value trade, expiring the day after an FOMC meeting, could become viable using the FLEX products.

The present invention relates to a platform for designing, creating and distributing financial instruments which allow investors to trade flex short term interest derivative contracts that can be customized to meet its investor's needs by choosing the actual terms of the contract from a list of flexible features that include but are not limited to strike prices, start and expiration dates or option pay-out styles. The designed investment vehicle would provide a relatively inexpensive choice to investors looking to hedge specific exposures to the movement of short term interest rate indicators in an exchange-listed environment. The result of this functionality benefits the customers and brokerage firms in the sense that the FLEX STIR contracts proposed herein are an attractive hybrid of aspects from listed and OTC markets, offering the best of each. The invented instrument's attributes include the anonymity, central clearing, margining and streamlined processing of listed contracts, while offering the flexibility and customization of OTC products.

Accordingly, the present invention provides a computer-implemented platform for creating, distributing, and clearing derivative instruments which reference a value of a short term interest rate indicator and are customized by an investing party. The platform performs the following steps: (a) establishing a set of standardized features for a short term interest rate (STIR) derivative product; (b) establishing a set of defined flexible features for the STIR derivative product, wherein each of the defined flexible features includes a plurality of pre-defined choices; (c) for each flexible feature in the set of defined flexible features, receiving a selection from the investing party of one of the plurality of pre-defined choices associated with the flexible feature; (d) customizing the STIR derivative product based on the selections received from the investing party; (e) entering information representative of the customized STIR derivative product into at least one of the following execution markets; (i) a two way quoted market for quoting two prices for buying and selling of the customized STIR derivative by a market maker; (ii) an exchange that receives a request for a quote (RFQ), announces the RFQ in a RFQ facility, responds to the RFQ by a market maker, and determines a best bid/offer by the RFQ facility; and (iii) an electronic matching system in which automatically matches bids and offers; (f) accepting a bid/offer match and executing the customized STIR derivative product; (g) submitting matching data to a clearing facility; (h) performing, by the clearing facility, a novation of the trades accepted by the facility; and (i) providing notification of settlement amounts by the clearing facility.

### BRIEF DESCRIPTION OF THE DRAWINGS

In the accompanying drawing:

FIG. 1 includes a schematic illustrating the method of the invention for creating and distributing financial products described in the present application.

### DETAILED DESCRIPTION OF THE INVENTION

For purposes of this application a “FLEX STIR Contract” refers to financial instruments which are tied to the value of an underlying short term interest rate indicator and allow investors to adapt flexible features such as exercise price, pay-out type, start and expiration dates, notional value or rate default, to existing short term interest rate derivative securities.

In the context of the presented invention “short term interest rate” or “STIR” means the interest rate earned by a debt instrument (such as a treasury bill or an interest rate indicator) that will mature within one year or less.

Additionally, the term “FLEX” refers to any derivative instrument, generally written by a clearing house, whose expiration date, strike price, exercising style and other features can be modified by the investing party.

A “futures exchange” or “derivatives exchange” in the context of the present application refers to a marketplace where futures and options contracts are traded.

The term “Request for Quote” in the embodiment of the present invention encompasses the initial request submitted by a submitting member of the exchange or FLEX facility.

A “FLEX facility” in the context of the present invention refers to the channel designated by the pertinent futures exchange to implement the trading of flexible derivative contracts.

The term “Best bid/offer” means the highest proposed quoted bid and offer to buy or sell a particular FLEX contract among all those offered by the members of the FLEX facility

A “Designated Clearing Organization” (DCO) is the exchange-affiliated agency responsible for settling trading accounts, clearing trades, collecting and maintaining margins, regulating delivery and reporting trading data.

The term “straight through processing” or “STP” refers to an initiative used by companies in the financial markets to optimize the speed at which transactions are processed. This is performed by allowing information that has been electronically entered to be transferred from one party to another in the settlement process without manually re-entering the same pieces of information repeatedly over the entire sequence of events.

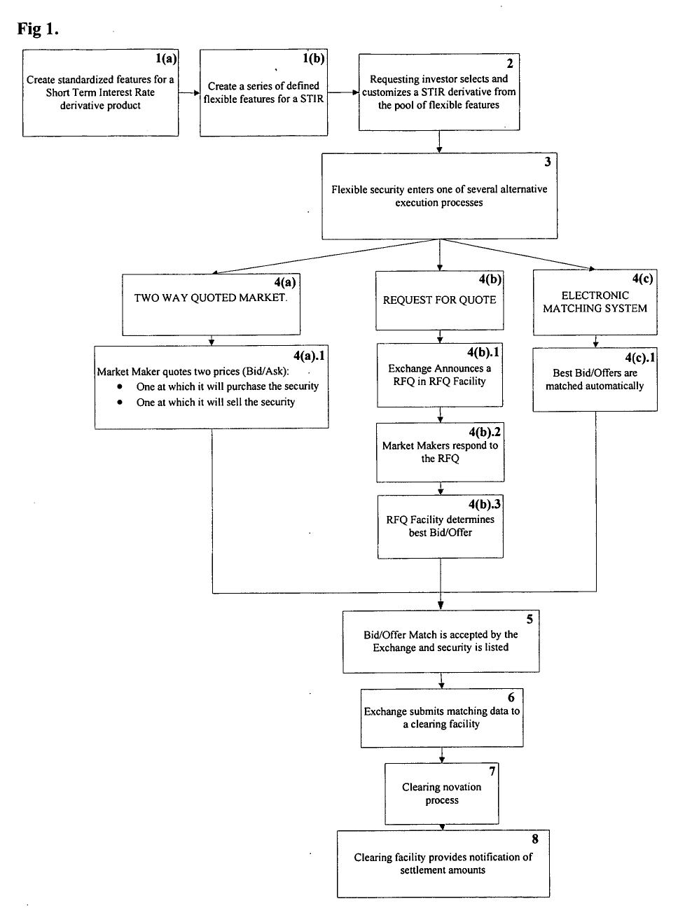

The present invention relates to a platform for creating, distributing, and clearing customized derivative instruments that are tied to the value of an underlying short term interest rate indicator, or derivatives for which the reference asset is a short-term interest rate. With the use of the STIR derivatives described in the present invention, investors are able to adapt flexible features such as strike price, exercise price, pay-out type, start and expiration dates, notional value or rate default, to existing interest rate options, allowing them to combine the flexibility of over-the-counter markets with the efficiency of organized exchanges, and the reliability of established facilities to provide the clearing and settlement of these contracts. In a preferred embodiment, the venue for the trading of the listed contracts, specifically a derivatives exchange with the appropriate regulatory designations, is likely to be most effective if implementation of the new STIR flexible contract is marketed to its investors through a distinct flex facility serving as channel for this product. The method of the present invention is illustrated in the flow chart in FIG. 1.

Step 1(a) in the method of the present invention involves the creation of standardized features for a given short term interest rate derivative product. By way of illustration, standardized contract features (which are not customizable by the investing party or trader of this instrument) in one embodiment may include some or all of the following: notional value, tick size, exercise style, exercise price, or settlement value. Step 1(b) involves the creation of a series of defined flexible features for the STIR contract (i.e., features which are customizable by the investing party) altering components such as strike prices, expiration date, or payout style, providing a new functionality in the marketplace when combined with the standardized features of Step 1(a). Step 1(b) also enables the designation (by the investing party) of a given listed instrument as a future, an option, an option on a future, or a future on an option.

In one embodiment, an exchange could list a series of consecutive daily maturities of a STIR contract as standardized features. These daily expiration features can offer enhanced functionality. To illustrate an example, these daily expiration flexible STIR contracts could be cash-settled against an interest rate and feature expiries every trading day of the year. The daily expiry function eliminates stub risk and date mismatches in the listed markets, while providing the benefits of a listed market. This product, for example, would enable a trade expiring the day of an important economic data release, tailoring the expiry to the risk. Under this embodiment, with the exchange listing multiple contracts featuring standardized daily expirations, the market would be enabled to create a range of applications for these products in their own right. It would also enable listed and OTC market participants to take an incremental step toward a hybrid marketplace until the futures industry has full capacity to list, clear, settle and process purely flexible transactions. Under this embodiment, the exchange-listed securities adopt flexibility in any combination of the other customizable features of the contract, including its notional value, strike price, payout style, type, etc. . . .

The flexible features offered in Step 1(b) may be broadly designed, so that the design provides optimal trading functionality, smoothing the progress of a method which will provide the investor multiple interest rate investment options with superior applications to contracts listed elsewhere, through an innovative flex option that determines its value according to the fluctuation of a particular short-term interest rate. These flexible features will offer common building-blocks of functionality, to enable simplicity of listing and clearing the instruments within certain defined parameters, while still offering the functionality of combining flexible elements in a customized fashion. The listing exchange would facilitate the selection of these flexible features by presenting them to the investors using a given exchange, in a graphical user-interface format where they can be combined with one another in a customized configuration, and paired with the standardized features common to each contract of a certain description.

Once one or more flexible features are offered to investors by the listing exchange, the investor customizes the provisions for a specific contract and determines the unique set of contract characteristics in terms of the preferences selected, as shown in Step 2. In one embodiment, an investor customizes a flexible aspect of a specific contract by selecting from a plurality of pre-defined choices for the particular aspect, using a graphical user-interface. For example, the user-interface may present the investing party with a plurality of pre-defined possible strike prices, expiration dates, and/or payout styles for a given contract, and the investing party chooses (from the pre-defined options) the strike price, expiration date, and/or payout style for the contract using the graphical user-interface. The breadth of these flexible features will determine the ability for an investor to customize the STIR contract to meet its investment needs. In order to be exercised, the customized instrument may undergo several alternative execution processes. In Step 3, the flexible security can enter into one of a variety of execution processes, providing a number of options available for the flexible STIR instruments to fill the buy and sell sides of the transaction and create a liquid, listed marketplace for these flexible instruments.

Step 4 (a) of the present invention comprises using a two-way quoted market in which the involvement of a third-party would contribute to providing efficiency and liquidity to the market of flexible STIR contracts. This third party market participant is likely to be, in a preferred embodiment, a market-making institution of significant size, one that is capable of covering volume attracted by the new trading venue and transacting trades on a routine basis. The third party participant may also be an entity or group within a market making institution, an entity associated with a market making institution, a group within the market making institution, or a combination thereof. The market making institution or firm could be contractually obligated to quote bids and offers to buy and sell the particular STIR derivative on a regular basis, and of a certain size of transaction, thus ensuring “liquidity” to brokers and customers interested in sending orders to this institution, firm, or exchange.

Initially, the contracts may require manual transactions and inputs, using Bloomberg or other data services to show indicative pricing, post RFQs. Transactions may be voice-brokered and manually input to a designated clearing facility, mirroring the block-trading practices currently implemented by other leading futures exchanges. This process may be maintained until the futures industry is prepared fully to support straight-through processing of FLEX products. When industry functionality is completed, FLEX transactions in the present invention may use a screen-based electronic trading platform, providing straight through processing for the FLEX contracts that are traded.

Step 4(a).1 identifies the process whereby the market making firm quotes two prices for the particular flexible STIR option. The market maker is required to give a price quote at which the firm would be willing to purchase (Bid) the customized STIR instrument, and at the same time provide an Ask quote or price at which it would agree to sell the derivative. The market maker provides this continuously quoted market on a certain basket of combinations of customized features, hence providing liquidity to a range of possible permutations.

An alternative embodiment for execution of the instrument could include the multi-staged request for quote process (RFQ) described in Steps 4(b) to 4(b).3 of the present invention. Step 4(b) comprises the event in which the investing member would submit a request to receive a price quotation for a certain combination of flexible features. In turn the exchange listing the flexible STIR derivative would announce the investor's request-for-quote in its RFQ facility, or designated medium (Step 4(b).1). Step 4(b).2 identifies the occurrence wherein the market maker or counter-party may respond to the RFQ. The market maker's response is governed by the conditions set forth by the trading venue and must be submitted within a specific timeframe designated by the exchange. Once all the responses from participating market making firms are received in the RFQ facility, the RFQ specialist designated by the exchange will determine the best bid/offer combination for the particular STIR trading instrument (Step 4(b).3). The four-stepped process described would require additional confirmation by the investing member.

Alternatively, another implementation and execution of the flexible STIR contract described in the present invention, as shown in Step 4(c), may use an all-electronic matching system powered by a platform of order-matching engines. This functionality eliminates the need for costly and duplicative trading floors, thus enabling the alternative marketplace to operate with lower relative costs, and competitive fee structures. In this embodiment, any authorized participant of the marketplace may submit either a bid or an offer for a given instrument at a given price. This submitted bid or offer would be for a specific set or combination of flexible features. The order-matching engine, using algorithms that are commonplace to practitioners of the arts, would enable a bid on a certain set of flexible features to be matched with an offer for a contract with the same combination of flexible features, at a common price that both parties indicate would be acceptable for transaction. No party to the transaction holds any specific obligation at any time to post prices or make markets, other than to honor a bid or offer that it has submitted for execution on a specific combination of features, at a specific price. Such electronic trading platforms have the additional benefit of enhanced speed of transaction, and the elimination of bias and advantage built into existing floor trading operations. The utilization of these order-matching engines to execute the best bid/offers automatically is shown in Step 4(c).1.

Notwithstanding the transaction methodology implemented in Steps 4a-4c to execute the STIR instrument, upon receipt of confirmation that two parties have agreed on a specific combination of flexible features at a specific price, in a certain number of contracts, the contract execution would be accepted by the regulated exchange and the execution of the contract in the market would be recorded, reported and disseminated according to standard procedures by means of Step 5 of the present invention. Following this acceptance, the exchange would submit the matching data to a Designated Clearing Organization (DCO), according to Step 6 of the process.

The clearing novation process (Step 7) can be performed by an established clearing facility, or DCO, under existing regulatory designation. The clearing facility for the new entity would be linked electronically to the system and would process, handle, report and clear transactions on an automated basis for the electronic exchange. In addition to holding customer and clearing member assets, the clearing facility has a segregated account of its own capital, which it uses to guarantee performance to each side of a transaction. This function ensures a high level of credibility and financial integrity, which in turn eliminates barriers to transacting business on an alternative marketplace. The clearing facility will confirm with each party of the trade the specific flexible features of the contract, the execution price, and the number of contracts executed.

In Step 8 the clearing facility will maintain this trading position on its books, report on it to each party, and collect and hold collateral to guarantee performance by each party, notifying settlement amounts, and pay or receive profits or losses to participants on a fixed, period basis. These functions will be performed by the clearing facility as long as the contract is open, or before expiration. The flexible contract features may not be changed in any fashion during this period.

The DCO in most embodiments will already be associated with an exchange, with appropriate processes already in place. In a preferred embodiment, the DCO will have a strategic fit with the marketplace of flexible STIR instruments, its order-flow providers and customers. These strategic fits include holding assets currently from these market participants as collateral for other, existing transactions, and having the ability to cross-margin or offset margin requirements on new listed contracts established on the alternative marketplaces, by mitigating risk through existing open positions.

Accordingly, the present invention provides a computer-implemented platform for creating, distributing, and clearing derivative instruments which reference a value of a short term interest rate indicator and are customized by an investing party. The platform performs the following steps: (a) establishing a set of standardized features for a short term interest rate (STIR) derivative product; (b) establishing a set of defined flexible features for the STIR derivative product, wherein each of the defined flexible features includes a plurality of pre-defined choices; (c) for each flexible feature in the set of defined flexible features, receiving a selection from the investing party of one of the plurality of pre-defined choices associated with the flexible feature; (d) customizing the STIR derivative product based on the selections received from the investing party; (e) entering information representative of the customized STIR derivative product into at least one of the following execution markets; (i) a two way quoted market for quoting two prices for buying and selling of the customized STIR derivative by a market maker; (ii) an exchange that receives a request for a quote (RFQ), announces the RFQ in a RFQ facility, responds to the RFQ by a market maker, and determines a best bid/offer by the RFQ facility; and (iii) an electronic matching system in which automatically matches bids and offers; (f) accepting a bid/offer match and executing the customized STIR derivative product; (g) submitting matching data to a clearing facility; (h) performing, by the clearing facility, a novation of the trades accepted by the facility; and (i) providing notification of settlement amounts by the clearing facility.

The graphical-user interface described above is implemented in software on a special purpose or general computer that is electronically coupled to the other components of the platform described above.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

We claim:

1. A computer-implemented method for creating, distributing, and clearing derivative instruments which reference a value of a short term interest rate indicator and are customized by an investing party, comprising:
(a) establishing a set of standardized features for a short term interest rate (STIR) derivative product;
(b) establishing a set of defined flexible features for the STIR derivative product, wherein each of the defined flexible features includes a plurality of pre-defined choices;
(c) for each flexible feature in the set of defined flexible features, receiving a selection from the investing party of one of the plurality of pre-defined choices associated with the flexible feature;
(d) customizing the STIR derivative product based on the selections received from the investing party;
(e) entering information representative of the customized STIR derivative product into at least one of the following execution markets; (i) a two way quoted market for quoting two prices for buying and selling of the customized STIR derivative by a market maker; (ii) an exchange that receives a request for a quote (RFQ), announces the RFQ in a RFQ facility, responds to the RFQ by a market maker, and determines a best bid/offer by the RFQ facility; and (iii) an electronic matching system in which automatically matches bids and offers;
(f) accepting a bid/offer match and executing the customized STIR derivative product;
(g) submitting matching data to a clearing facility;
(h) performing, by the clearing facility, a novation of the trades accepted by the facility; and
(i) providing notification of settlement amounts by the clearing facility.

2. The method of claim 1, wherein the customized STIR derivative product is a futures contract.

3. The method of claim 1, wherein the customized STIR derivative product is an options contract.

4. The method of claim 1, wherein the customized STIR derivative product is an option on a futures contract.

5. The method of claim 1, wherein the customized STIR derivative product is a futures contract on a options contract.

6. The method of claim 1, wherein the flexible features customized by the investing party include at least one of the following:
a) Exercise price;
b) Start date;
c) Expiry;
d) Strike Price;
e) Notional value;
f) Payout style;
g) Rate default.

7. The method of claim 1, wherein the standardized features of the described contracts include any combination of the following:
a) Exercise price
b) Start date
c) Expiry
d) Strike Price
e) Notional value
f) Payout style
g) Rate default

8. The method of claim 1, wherein any investing member may request to list a customized STIR derivative product in which terms of the product are not initially offered in the set of defined flexible features.

9. The method of claim 1, wherein an exchange lists a series of daily maturities of the customized STIR derivative product as standardized features.

10. The method of claim 9, wherein the daily maturities consist of all days in which the exchange and clearing facility are open for business.

11. A system for creating, distributing, and clearing derivative instruments which reference a value of a short term interest rate indicator and are customized by an investing party, comprising a at least one processor that runs software which executes the following steps:
(a) establishing a set of standardized features for a short term interest rate (STIR) derivative product;
(b) establishing a set of defined flexible features for the STIR derivative product, wherein each of the defined flexible features includes a plurality of pre-defined choices;
(c) for each flexible feature in the set of defined flexible features, receiving a selection from the investing party of one of the plurality of pre-defined choices associated with the flexible feature;
(d) customizing the STIR derivative product based on the selections received from the investing party;
(e) entering information representative of the customized STIR derivative product into at least one of the following execution markets; (i) a two way quoted market for quoting two prices for buying and selling of the customized STIR derivative by a market maker; (ii) an exchange that receives a request for a quote (RFQ), announces the RFQ in a RFQ facility, responds to the RFQ by a market maker, and determines a best bid/offer by the RFQ facility; and (iii) an electronic matching system in which automatically matches bids and offers;
(f) accepting a bid/offer match and executing the customized STIR derivative product;
(g) submitting matching data to a clearing facility;
(h) performing, by the clearing facility, a novation of the trades accepted by the facility; and
(i) providing notification of settlement amounts by the clearing facility.
